(19) United States
(12) Patent Application Publication
(10) Pub. No.: US 2007/0042239 A1
(43) Pub. Date: Feb. 22, 2007

(54) Fuel cell system

(75) Inventors: Sun-Wei Chang, Taipei City (TW); Yin-Pu Chen, Taipei City (TW); Min-Hsien Lin, Taipei City (TW); Chien-Wen Chen, Taipei City (TW)

Correspondence Address: BACON & THOMAS, PLLC, 625 SLATERS LANE, FOURTH FLOOR, ALEXANDRIA, VA, 22314, US

(73) Assignee: Tatung Company, Taipei City (TW)

(21) Appl. No.: 11/262,790

(22) Filed: Nov. 1, 2005

(30) Foreign Application Priority Data
Aug. 19, 2005 (TW) 094128400

(51) Int. Cl. H01M 8/06; H01M 8/04

(52) U.S. Cl. 429/19; 429/26

(57) ABSTRACT

A fuel cell system has a distributor, at least one catalytic converter for the reformation reaction and a stack. When the fuel cell system has more than two catalytic converters for the reformation reaction a converging chamber can be added into the system to input the hydrogen gas generated by the catalytic converter for the reformation reaction to the stack. Therefore, the present invention can integrate the catalytic converter for the reformation reaction and the stack to reduce both the cost and fuel cell volume, and save fuel.

### BACKGROUND OF THE INVENTION

1. Field of the Invention

The present invention relates to fuel cells, and more particularly, to a fuel cell system capable of reducing the volume of fuel cells.

2. Description of the Related Art

With growing environmental concerns, as well as energy shortages, new energy sources are being sought all over the world. Of the various alternative energies, the fuel cell is one of the most desirable, as it combines hydrogen with oxygen to generate electric energy, and produces only water as a waste product; hence, the fuel cell is looked to as a way to efficiently reduce environment pollution.

However, the typical fuel cell stacks tend to be damaged by CO, which reduces their efficiency. A catalytic converter for the reformation reaction is thus used to remove CO. The catalytic converter for the reformation reaction needs to perform 5 to 6 chemical reactions to remove CO, and each chemical reaction requires a different catalytic converter for the reformation reaction and an individual layer in the catalytic converter for the reformation reaction, which leads to excessive volumes and costs.

Additionally, the operating temperature of the catalytic converter for the reformation reaction is very different from the working temperature of the stack; consequently, a user must separately provide heat to the catalytic converter for the reformation reaction and to the stack, which can lead to waste. Moreover, the catalytic converter for the reformation reaction requires many layers, which result in water, heat and electrical integration problems, and large volumes that make moving and storage difficult.

Therefore, it is desirable to provide a fuel cell system to mitigate and/or obviate the aforementioned problems.

### SUMMARY OF THE INVENTION

The present invention provides a fuel cell system, which comprises a distributor, at least one catalytic converter for the reformation reaction and a stack. The distributor has an inlet, at least one outlet and a central channel, wherein the central channel is connected to the inlet and the at least one outlet, the inlet used for injecting fuel, the fuel vaporized in the central channel and output by the at least one outlet. Each catalytic converter for the reformation reaction has an fuel inlet and an fuel outlet, the fuel inlet is connected to a corresponding at least one outlet of the distributor; the fuel inlet is used for injecting the vaporized fuel, and the fuel outlet is used for outputting reformed fuel. The stack has a fuel inlet, a air inlet, a air outlet, and a fuel outlet; the fuel inlet is connected to the fuel outlet of the at least one catalytic converter for the reformation reaction and is used for injecting the reformed fuel, the air inlet is used for inputting air, the air outlet being used for removing water in the stack after a reaction has occurred, and the fuel outlet is used for removing residual gas in the stack after the reaction has occurred.

Therefore, the present invention can integrate the catalytic converter for the reformation reaction and the stack to reduce both the cost and fuel cell volume, and save fuel.

Furthermore, when the fuel cell system has more than two catalytic converters for the reformation reaction a converging chamber can be added into the system. The converging chamber comprises at least two entrances and an exit. The entrance is correspondingly connected to the fuel outlet of the at least one catalytic converter for the reformation reaction, and the exit is connected to the fuel inlet of the stack. By adding the converging chamber, the fuel cell system can converge the catalytic converters in the reformation reactor to increase the efficiency of the fuel cell system.

The fuel cell system further comprises at least one cooling fin mounted on the stack, which is used for dissipating heat generated by the fuel cell system.

Furthermore, the distributor and the stack of the fuel cell can be tightly combined by at least one bolt, or by other methods such as fastener elements, glue or clips.

Similarly, the at least one catalytic converter for the reformation reaction and the stack of the fuel cell system can be tightly combined by at least one screw, or by other methods such as fastener elements, glue or clips.

Other objects, advantages, and novel features of the invention will become more apparent from the following detailed description when taken in conjunction with the accompanying drawings.

### BRIEF DESCRIPTION OF THE DRAWINGS

FIG. 1 is an exploded view of a first embodiment of the present invention.

FIG. 2 is a perspective view of the first embodiment of the present invention.

FIG. 3 is a side view of the first embodiment of the present invention.

FIG. 4 is an exploded view of a second embodiment of the present invention.

### DETAILED DESCRIPTION OF THE PREFERRED EMBODIMENT

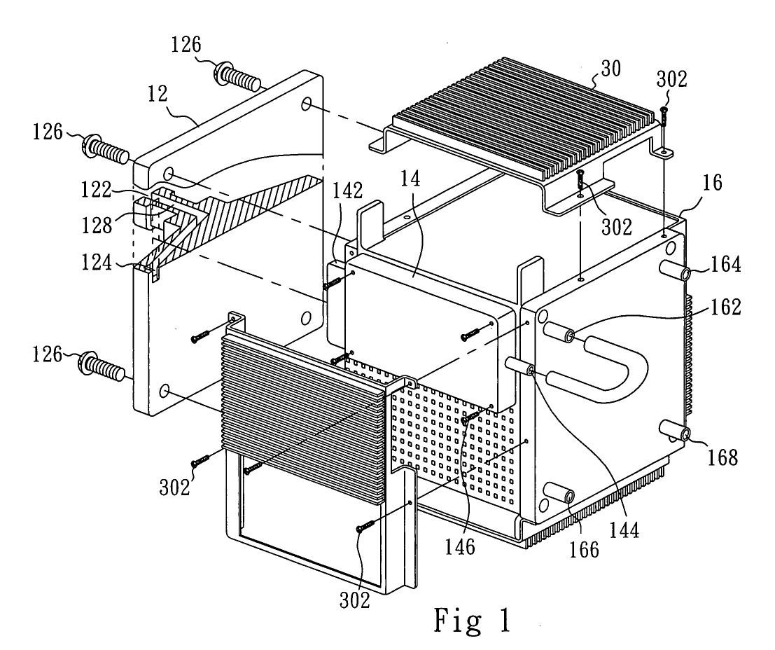

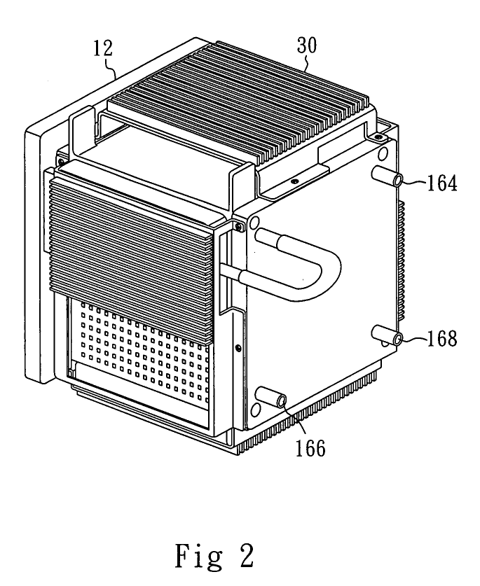

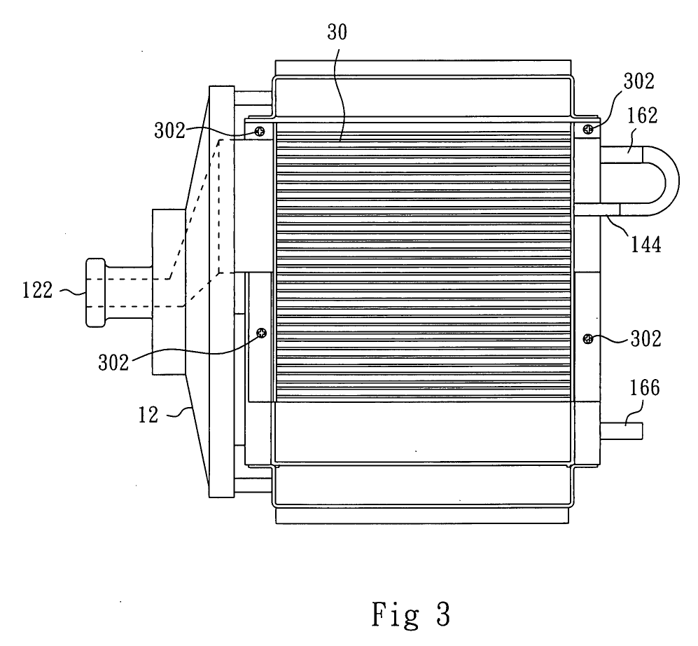

Please refer to FIG. 1, FIG. 2 and FIG. 3. FIG. 1 is an exploded view of a first embodiment of the present invention. FIG. 2 is a perspective view of the first embodiment of the present invention. FIG. 3 is a side view of the first embodiment of the present invention. The present invention is a fuel cell system that comprises a distributor 12, a catalytic converter for a reformation reactor 14 and a stack 16.

In this embodiment, the distributor 12 comprises an inlet 122, an outlet 124 and a central channel 128. The central channel 128 of the distributor 12 is connected to the inlet 122 and the outlet 124. Fuel is injected at the inlet 122, vaporized in the central channel 128, and then output from the outlet 124. Four bolts 126 are used to tightly mount the distributor 12 on the stack 16.

The catalytic converter for the reformation reaction 14 comprises an fuel inlet 142 and an fuel outlet 144. The fuel inlet 142 of the catalytic converter for the reformation reaction 14 is connected to the corresponding outlet 124 of the distributor 12; the fuel inlet 142 is used for injecting the vaporized fuel, and the fuel outlet 144 is used for outputting reformed H₂ gas. Four screws 146 are used to tightly mount the catalytic converter for the reformation reaction 14 on the stack 16.

The stack 16 has a fuel inlet 162, a air inlet 164, a air outlet 166, and a fuel outlet 168. The fuel inlet 162 of the stack 16 is connected to the fuel outlet 144 of the catalytic converter for the reformation reaction 14 and is used for injection of the reformed H₂ gas. The air inlet 164 is used for inputting air. Both the air outlet 166 and fuel outlet 168 are used for removing water and residual gas in the stack 16 after reaction has occurred.

The fuel cell system of the present invention combines together the catalytic converter for the reformation reactor 14 and the stack 16 to reduce both the volume and manufacturing costs of the fuel cell system, as well as to save materials.

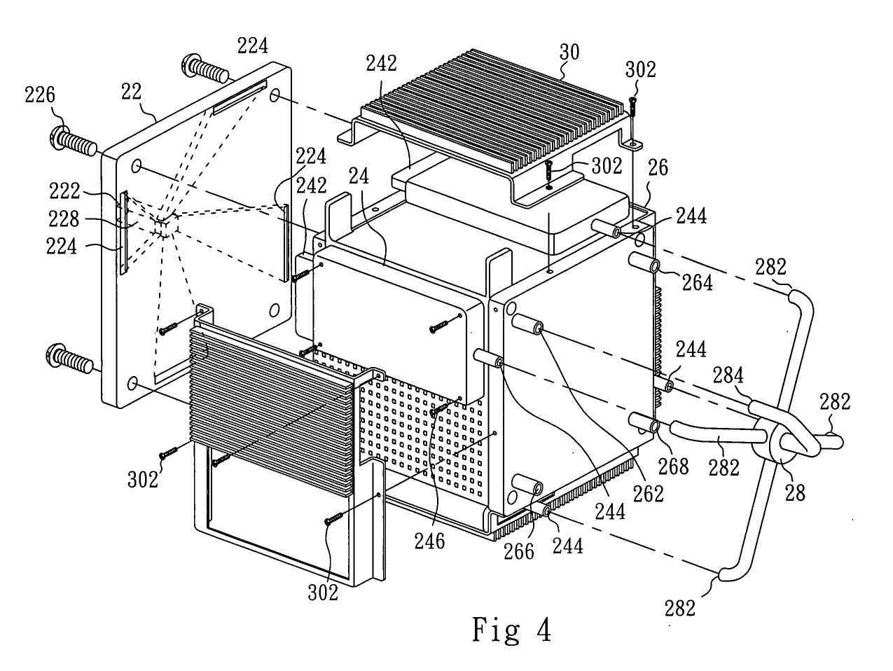

Please refer to FIG. 4. FIG. 4 is an exploded view of a second embodiment of the present invention. A difference between this embodiment and the previous embodiment is the quantity of the catalytic converters for the reformation reaction 24. As shown in FIG. 4, four catalytic converters are used in the reformation reactor 24; consequently, a converging chamber 28 is utilized. The converging chamber 28 comprises four entrances 282 and an exit 284. The four entrances 282 of the converging chamber 28 are correspondingly connected to four fuel outlets 244 of the catalytic converter for the reformation reaction 24, and are used for inputting reformed fuel. The exit 284 of the converging chamber 28 is connected to the fuel inlet 262 of the stack 26 and is used for outputting converged fuel. Four outlets on the distributor 22 correspond to the four fuel inlets 242 of the catalytic converter for the reformation reaction 24. By adding the converging chamber 28, the fuel cell system can converge the catalytic converter for the reformation reaction 24 to increase the efficiency of the fuel cell system.

The present invention may further comprise four cooling fins 30 mounted on the stack 16, which are used for controlling heat generated by the fuel cell system. As shown in FIG. 4, all four cooling fins 30 are mounted on the stack 16 via four bolts 302.

Although the present invention has been explained in relation to its preferred embodiment, it is to be understood that many other possible modifications and variations can be made without departing from the spirit and scope of the invention as hereinafter claimed.

What is claimed is:

1. A fuel cell system comprising:
a distributor comprising an inlet, at least one outlet and a central channel, wherein the central channel is connected to the inlet and the at least one outlet, the inlet used for injecting fuel, the fuel being vaporized in the central channel and output by the least one outlet;
at least one catalytic converter for the reformation reaction, each catalytic converter for the reformation reaction comprising an air inlet and an air outlet, the air inlet connected to a corresponding at least one outlet of the distributor; the air inlet used for injecting the vaporized fuel, and the air outlet used for outputting reformed fuel; and
a stack, comprising a first air inlet, a second air inlet, a first air outlet, and a second air outlet, the first air inlet connected to the air outlet of the at least one catalytic converter for the reformation reaction and used for injecting the reformed fuel, the second air inlet used for inputting air, the first air outlet being used for removing water in the stack after a reaction has occurred, and the second air outlet used for removing gas in the stack after the reaction has occurred.

2. The fuel cell as claimed in claim 1, wherein the fuel cell system further comprises a converging chamber; wherein the converging chamber comprises at least one entrance and an exit, the entrance correspondingly connected to the air outlet of the at least one catalytic converter for the reformation reaction, and the exit is connected to the first air inlet of the stack.

3. The fuel cell as claimed in claim 1 further comprising at least one cooling fin mounted on the stack.

4. The fuel cell as claimed in claim 1, wherein at least one bolt attaches the distributor to the stack.

5. The fuel cell as claimed in claim 1, wherein at least one screw is used to attach the at least one catalytic converter for the reformation reaction onto the stack.
